(19) United States
(12) Patent Application Publication
(10) Pub. No.: US 2009/0259374 A1
(43) Pub. Date: Oct. 15, 2009

(54) METHOD OF CONTROLLING A TRANSMISSION RATIO

(75) Inventors: Markus Weber, Ulm (DE); Jurgen Winkelhake, Neu-Ulm (DE)

Correspondence Address: SCULLY SCOTT MURPHY & PRESSER, PC, 400 GARDEN CITY PLAZA, SUITE 300, GARDEN CITY, NY, 11530, US

(73) Assignee: BRUENINGHAUS HYDROMATIK GMBH, Elchingen (DE)

(21) Appl. No.: 12/306,873

(22) PCT Filed: Jun. 20, 2007
(86) PCT No.: PCT/EP2007/005444

§ 371 Date: Dec. 29, 2008

(30) Foreign Application Priority Data
Jun. 28, 2006 (DE) 10 2006 029 674.5
Aug. 3, 2006 (DE) 10 2006 036 317.5

(51) Int. Cl. G06F 19/00

(52) U.S. Cl. 701/58

(57) ABSTRACT

The invention relates to a method for controlling a transmission ratio (r) of a continuously adjustable transmission (3). An accelerator pedal position and an actual driving speed (VU_{actual}) are acquired. By consideration of the actual driving speed (V_{actual}) and the accelerator pedal position (α_{Pedal}), a transmission gradient is determined. A target transmission ratio is determined as the sum of an actual transmission ratio (r_{actual}) and a transmission adjustment value (formula I), and the continuously adjustable transmission (3) is set to this ratio.

The invention relates to a method of controlling a transmission ratio in an infinitely variable gear unit.

When providing the drive for utility vehicles, such as wheeled loaders for example, use is usually made of a hydrodynamic power-shift gear unit or a hydrostatic traction drive. When a power-shift gear unit is used, an injection quantity for the diesel engine is preset by the driver by means of an accelerator pedal position. The fixed gear ratio of the power-shift gear unit results in a direct correlation between the rotational speed set for the diesel engine and the speed of travel. In the course of a working operation, for example the lifting of a full shovel, however, a large part of the available driving energy of the diesel engine must be made available to the working hydraulics. This requires a high, constant rotational speed of the diesel engine. So as not to simultaneously increase the speed of travel in an unintended manner, the power flux in the drive is regulated by actuating a so-called “inching pedal”, or is restrained via the service brake, so that the differential speed of rotation is represented via the converter.

In hydrostatic traction drives, the so-called “automotive traction” is realised with the aid of a hydraulic adjusting arrangement. As an infinitely variable gear unit, the hydrostatic gear unit comprises at least one hydraulic pump and a hydraulic motor, it being possible to set the angle of pivoting of at least the hydraulic pump. Adjustment of the angle of pivoting takes place in dependence upon an accelerator pedal position and also upon pressurisation of the diesel engine. As a result, the setting of the hydrostatic gear unit depends, even in a hydrostatic traction drive, upon the rotational speed of the diesel engine that is set up.

The underlying object of the invention is therefore to provide a method of controlling a transmission ratio in an infinitely variable gear unit which permits independent adjustment of the rotational speed of the diesel engine and thus represents a high degree of operating convenience for the driver, since an accelerator pedal position preset by the driver represents a specific desire for acceleration.

This object is achieved by means of the method according to the invention having the features in claim 1.

According to the method in claim 1, in order to control the transmission ratio of an infinitely variable gear unit, an accelerator pedal position α_{Pedal} is first of all detected. The current speed of travel of the vehicle at any point in time is also detected as the actual speed of travel vᵢₛₜ. A transmission gradient

$$\frac{d}{d t} {r}_{soll}$$

is determined allowing for both the accelerator pedal position α_{Pedal} and the actual speed of travel vᵢₛₜ. Under these circumstances, the transmission gradient

$$\frac{d}{d t} {r}_{soll}$$

designates the change in the transmission ratio rₛₒₗₗ(t) of the hydrostatic gear unit per unit of time. Adopting an actual transmission ratio and the transmission gradient

$$\frac{d }{d t} {r}_{soll} ( t )$$

as the starting point, a new ideal transmission value rₛₒₗₗ(t+Δt) is set, said new ideal transmission value being the sum of the actual transmission ratio and the transmission gradient

$$\frac{d }{d t} {r}_{soll} ( t ) ,$$

multiplied by a time interval Δt.

The method according to the invention has the advantage that the acceleration realised is set by presetting the speed with which the transmission ratio rₛₒₗₗ changes during accelerated travel. A specific desire for acceleration is thereby realised, starting from the particular accelerator pedal position α_{Pedal}. It is thus possible to set a constant rotational speed, which is necessary for delivering a high output, at the diesel engine during travel, with the simultaneous actuation of working hydraulics. The acceleration of the vehicle is realised, starting from this constant rotational speed but independently of the rotational-speed regulation of the diesel engine, by setting the transmission ratio of an infinitely variable gear unit, such as a hydrostatic gear unit for example. It is also conceivably possible to use mechanical infinitely variable gear units instead of an infinitely variable gear unit in the form of a hydrostatic gear unit with a pump/motor combination.

Advantageous further developments of the method according to the invention are set out in the subclaims.

In particular, it is advantageous to allow for the speed of travel vᵢₛₜ by calculating an allowance-making value α_{Pedal,grenz}, said allowance-making value α_{Pedal,grenz} containing a ratio consisting of an actual speed of travel vᵢₛₜ and a maximum speed of travel vₘₐₓ of the vehicle. It is particularly advantageous if the allowance-making value α_{Pedal,grenz} and the accelerator pedal position α_{Pedal} detected are combined to form a characteristic quantity for the desire for acceleration, which characteristic quantity is used as a basis for determining the transmission gradient

$$\frac{d }{d t} {r}_{soll} ( t ) .$$

In addition to the desire for acceleration actually manifested by the driver, that is to say the presetting of a specific accelerator pedal position, allowance is thus made for the actual speed of travel vᵢₛₜ of the vehicle. As a result, the change in the ideal transmission rₛₒₗₗ can be scaled, in a simple manner, in dependence upon the current speed of travel vᵢₛₜ.

Under these circumstances, the characteristic quantity for the desire for acceleration (α_{Pedal}−α_{Pedal,grenz}) is preferably formed as the difference (α_{Pedal}−α_{Pedal,grenz}) between the accelerator pedal position detected and the allowance-making value. Said characteristic quantity for the desire for acceleration (α_{Pedal}−α_{Pedal,grenz}) can thus be used in almost any desired functions which ultimately establish the transmission gradient

$$\frac{d }{d t} ( r ( t ) ) .$$

In the simplest case, this may take place in accordance with a linear equation. However, it is also possible, by means of a suitable parametrisation that differs from this equation, to also achieve another characteristic profile which corresponds to the typical behaviour of a driver when actuating the accelerator pedal.

It is also advantageous, when calculating the allowance-making value (α_{Pedal}−α_{Pedal,grenz}), to allow for another output requirement in addition to the actual speed of travel vᵢₛₜ.

Said other output requirement may, for example, be determined on the basis of a signal from an inching pedal. With the aid of the inching pedal position α_{inch}, the driver of a utility vehicle of this kind, for example a wheeled loader, establishes what portion of the output is currently needed for the working hydraulics. The remaining portion of the output is available to the traction drive. As the output requirement defined in this way is contained in the allowance-making value (α_{Pedal}−α_{Pedal,grenz}), the transmission gradient

$$\frac{d }{d t} {r}_{soll} ( t )$$

is established while allowing not only for the current speed of travel vᵢₛₜ, but also for other output requirements. The converted acceleration thus requires a low output contribution since the transmission gradient, for example for an acceleration, is chosen so as to be correspondingly lower.

The method of controlling the transmission ratio r(t) is represented diagrammatically in the drawings and will be explained in greater detail in the description that follows. In said drawings:

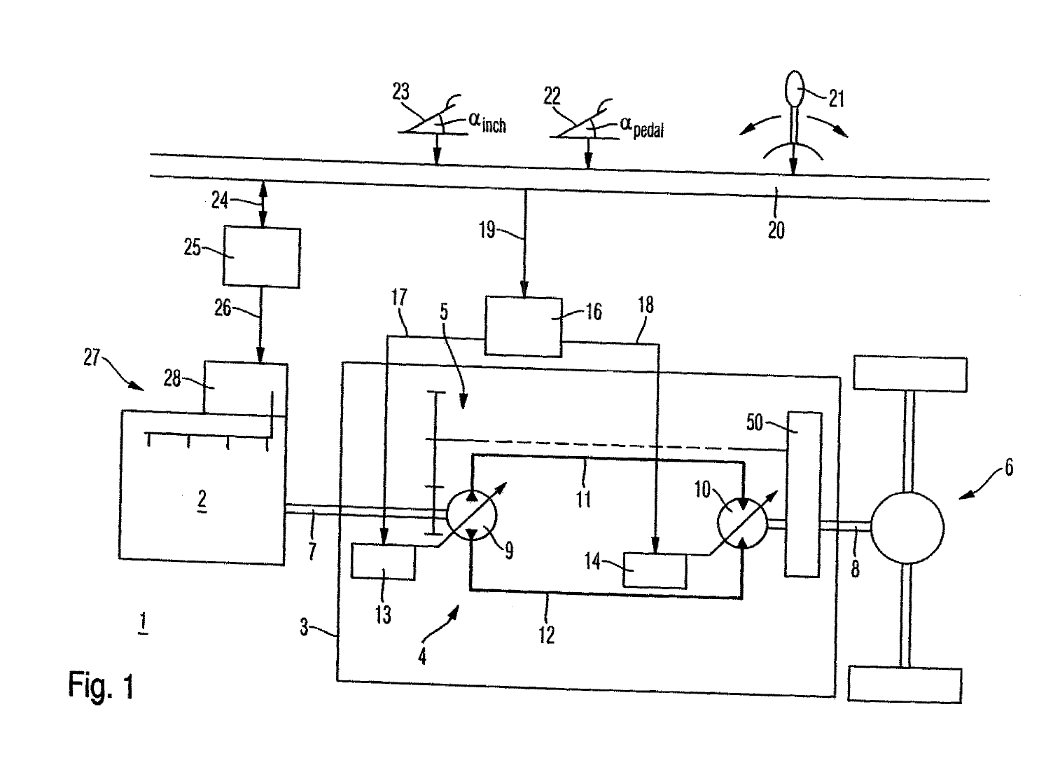

FIG. 1 shows a diagrammatic representation of a traction drive for carrying out the method according to the invention;

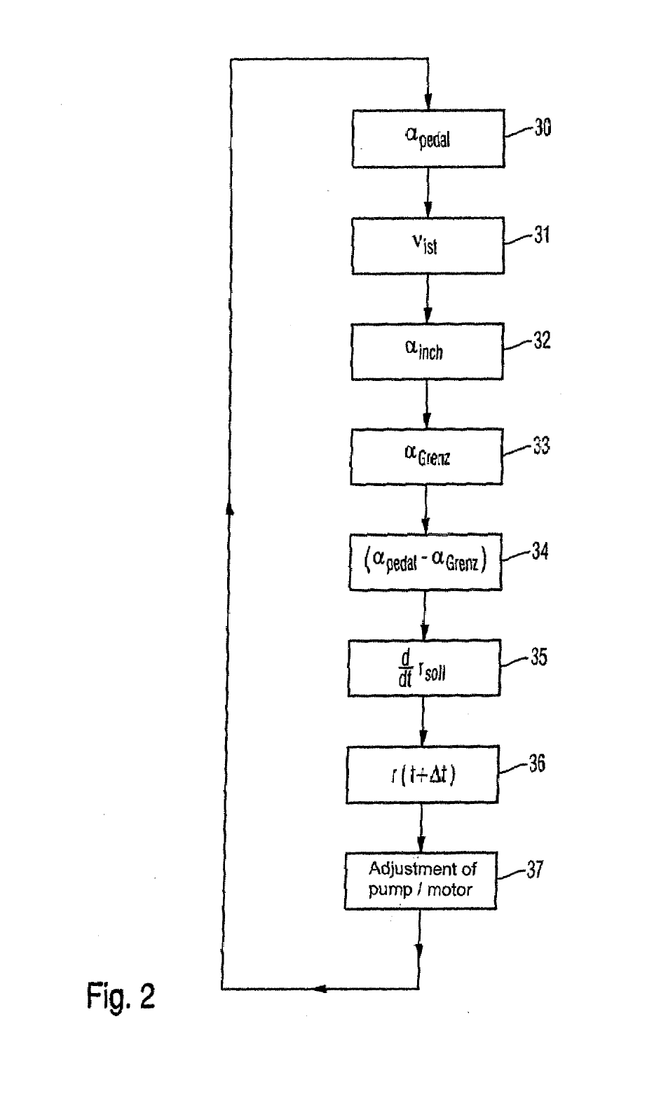

FIG. 2 shows a simplified representation of a procedural sequence for the method according to the invention;

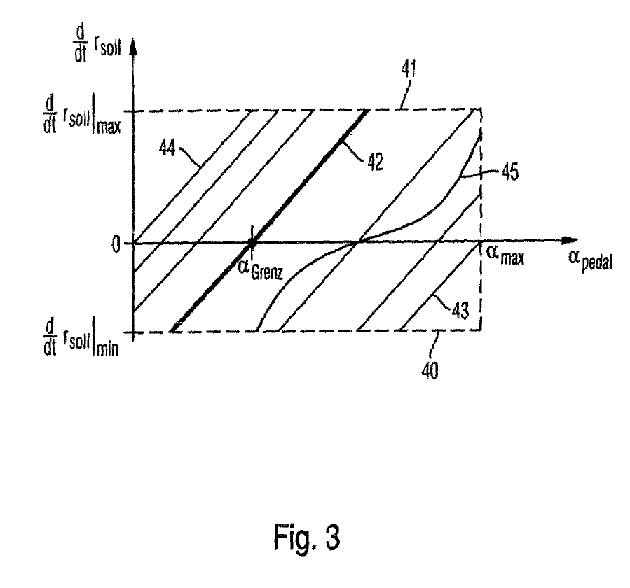

FIG. 3 shows a diagram for explaining the driving strategy according to the invention;

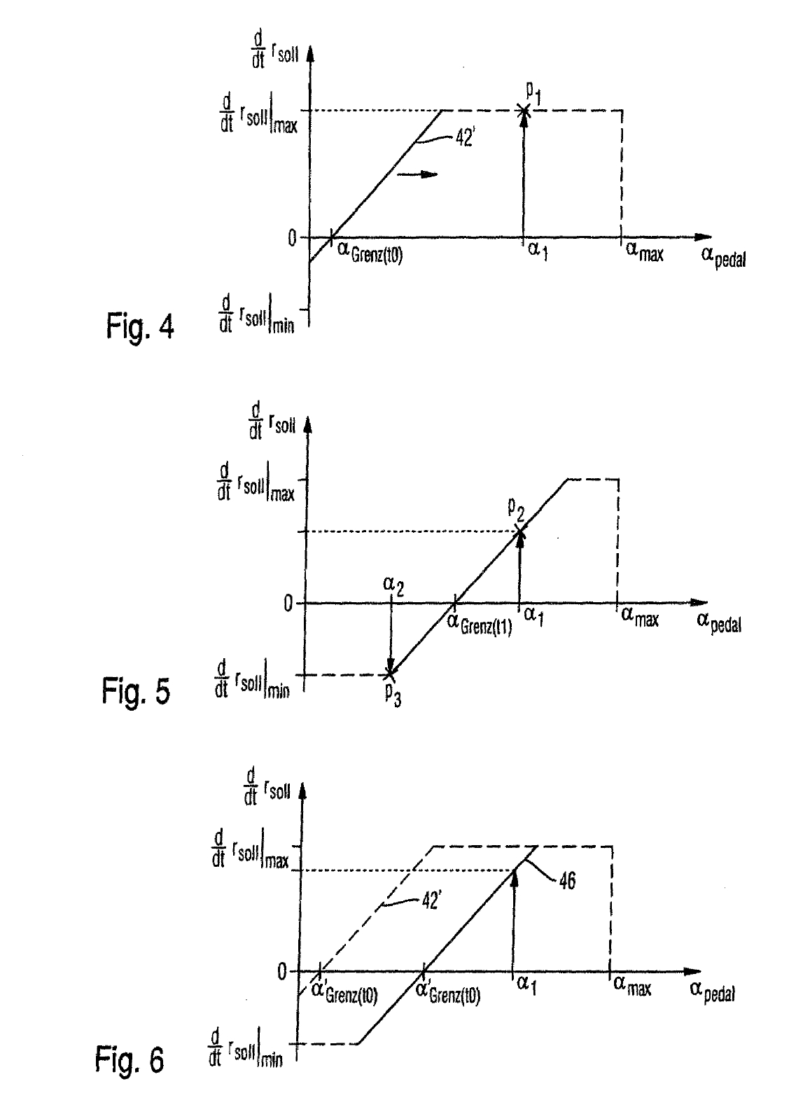

FIG. 4 shows a first example of a specific driving situation;

FIG. 5 shows a second example of a specific driving situation; and

FIG. 6 shows a third example of another driving situation.

Before going into the carrying-out of the method according to the invention, a traction drive 1 of a utility vehicle, which drive is used for this purpose, will be explained first of all. A traction drive 1 of this kind is represented in FIG. 1. Said traction drive 1 is driven by a diesel internal combustion engine 2 as the primary driving source. Said diesel internal combustion engine 2 is connected to an output-branching gear unit 3. Said output-branching gear unit 3 comprises a first output branch which is designed as a hydrostatic gear unit 4. A mechanical branch 5 of the gear unit is provided in parallel thereto.

Both the hydrostatic gear unit 4 and the mechanical branch 5 of the gear unit are connected to a driven axle 6 of the vehicle. For this purpose, the output-branching gear unit comprises a summing gear unit section 50 which is designed as a planetary gear unit.

A driving shaft 7 which connects the diesel internal combustion engine 2 to the output-branching gear unit 3 is provided on the input side of the gear unit. On the output side, the output-branching gear unit 3 connects an output shaft 8 to, for example, a rear-axle differential of the vehicle which is being driven.

The hydrostatic gear unit 4 comprises a hydraulic pump 9 and a hydraulic motor 10. Said hydraulic pump 9 and hydraulic motor 10 are connected to one another in a closed hydraulic circuit. For this purpose, the connections of the hydraulic pump 9 and hydraulic motor 10 are connected via a first working line 11 and a second working line 12, respectively.

The delivery volume of the hydraulic pump 9 can be set and said pump is preferably designed for delivery in two directions. Thus, pressure medium can be delivered by the hydraulic pump 9 either into the first working line 11 or else into the second working line 12. It is possible to set forward or backward travel, depending upon which direction of delivery of the hydraulic pump 9 has been set. A first adjusting device 13 serves to adjust the hydraulic pump 9. Said first adjusting device 13 interacts with an adjusting mechanism belonging to the hydraulic pump 9. In the same way, a second adjusting device 14, which acts on an adjusting mechanism belonging to the hydraulic motor 10, is provided. Said hydraulic motor 10 can thus likewise be set with respect to its absorption volume.

The transmission ratio r(t) of the hydrostatic gear unit is produced by that angle of pivoting of the hydraulic pump 9 or hydraulic motor 10 which has been set in each case.

An electronic control unit 16 is provided for setting the angle of pivoting of the hydraulic pump 9 and hydraulic motor 10. Said electronic control unit 16 is connected to the first adjusting device 13 via a first control signal line 17. The electronic control unit 16 is also connected to the second adjusting device 14 via a second control signal line 18. The adjusting devices 13, 14 may have hydraulic valves which are actuated, for example, via a proportional magnet and which set a positioning pressure which prevails in a positioning cylinder.

In the exemplified embodiment represented, the electronic control unit 16 is connected to a CAN bus 20 via a connecting line 19. Via said CAN bus 20, the electronic control unit 16 receives information about the position α_{Pedal} of an accelerator pedal 22 and also about the position α_{inch} of an inching pedal 23. The use of a CAN bus for communication between the controls, which are operated by the driver of the utility vehicle, and the electronic control unit 16 is to be understood merely as an example. Direct linking via individual signal lines is also possible. For illustration purposes, another control lever 21, which is likewise connected to the CAN bus 20, is shown as an example. Said control lever 21 serves, for example, for raising and lowering a shovel.

In addition, a drive-controlling apparatus 25 is connected to the CAN bus 20 via another signal line 24. Said drive-controlling apparatus 25 interacts, via an injection signal line 26, with an injection system 27 belonging to the diesel internal combustion engine 2. The injection system 27 of the diesel internal combustion engine 2 comprises an injection pump 28. A specific injection quantity is injected into said diesel internal combustion engine 2 in dependence upon the injection signal arriving via the signal line 26. As a result of this, a specific rotational speed on the part of the diesel internal combustion engine 2 is set up with an available output which is sufficient for the output-consumers.

In the case of all the following approaches, it is assumed that the rotational speed of the diesel internal combustion engine which has been set in this way is sufficient for the output which is required, whether it is required by the working hydraulics or else by the traction drive, or by a combination thereof.

In the simple case of a pure traction operation, the driver presets a specific desire for acceleration by actuating the accelerator pedal 22. In its position α_{Pedal}, said accelerator pedal 22 can be set between a zero angle and a maximum position αₘₐₓ. The maximum accelerator pedal position which can be preset by the driver, starting from the stationary state of the vehicle, is thus the position αₘₐₓ. This corresponds to the desire for the greatest possible acceleration. If the vehicle has been standing still initially, the greatest possible acceleration is achieved through the fact that the transmission ratio r(t) of the hydrostatic gear unit 3 per unit of time is adjusted by a large value.

The establishing of the transmission ratio, which is carried out by the electronic control apparatus 16, takes place on the basis of the equation:

$${r}_{soll} ( t + Δ t ) = {r}_{soll} ( t ) + \frac{d }{d t} {r}_{soll} \cdot Δ t \qquad ( 1 )$$

In said equation,

$$\frac{d }{d t} {r}_{soll}$$

constitutes a transmission gradient.

Said transmission gradient

$$\frac{d }{d t} {r}_{soll} ,$$

multiplied by a time interval Δt, results in a transmission-changing value by which the ideal transmission ratio rₛₒₗₗ(t) is changed on the basis of the driver's desire for acceleration per time interval Δt. From that ideal transmission value r(t+Δt) which has thus been determined at the point in time (t+Δt), the electronic control unit 16 determines the angles of pivoting required in each case for the hydraulic pump 9 and the hydraulic motor 10. The control signals thus determined are fed to the first adjusting device 13 or to the second adjusting device 14 via the first control signal line 17 or second control signal line 18, respectively.

In addition to the accelerator pedal position α_{Pedal} preset by the driver, a so-called “allowance-making value” is used for determining the transmission gradient

$$\frac{d }{d t} {r}_{soll} ( t ) .$$

In the simplest case involving a pure traction drive control, said allowance-making value allows for the actual speed vᵢₛₜ of the vehicle at the time. This leads to the fact that, for a desire for acceleration which is preset by the driver by depressing the accelerator pedal 22, a characteristic quantity for the desire for acceleration (α_{Pedal}−α_{Pedal,grenz}) is determined, which contains both the allowance-making value α_{Pedal,grenz} and also the accelerator pedal position α_{Pedal}. The characteristic quantity for the desire for acceleration is preferably the difference between the accelerator pedal position α_{Pedal} and the allowance-making value α_{Pedal,grenz}. Said allowance-making value α_{Pedal,grenz} will be designated below as the “limiting pedal position”, the said limiting pedal position being a hypothetical pedal position value. The transmission gradient

$$\frac{d }{d t} {r}_{soll} ( t )$$

can be determined with the aid of the following correlation:

$$\frac{d }{d t} {r}_{soll} {{\vert}_{min} \leq \frac{d }{d t} {r}_{soll} = m ( {α}_{Pedal} - {α}_{Pedal , grenz} ) \leq \frac{d }{d t} {r}_{soll} \vert}_{max} \qquad ( 2 )$$

Because the current speed of travel vᵢₛₜ is allowed for in the allowance-making value α_{Pedal,grenz}, the transmission gradient

$$\frac{d }{d t} {r}_{soll} ( t )$$

is scaled, in dependence upon the current speed of travel, from the maximum possible speed of travel vₘₐₓ. The correlation for determining the limiting pedal value α_{Pedal,grenz} works out at:

$$O \leq {α}_{Pedal , grenz} = {α}_{max} \frac{{v}_{fahr}}{{v}_{max}} \leq 1 \qquad ( 3 )$$

The use of the allowance-making value makes it possible to also allow for other characteristic quantities in addition to those which are purely dependent upon the traction drive. In particular, it is possible to allow for another output requirement which exists, for example, because of working hydraulics. For this purpose, the driver presets, by means of an inching pedal 23, what portion of the maximum available output of the diesel internal combustion engine 2 is to be available to the working hydraulics, which are not represented in the figure, and what portion to the traction drive. Allowing for the inching pedal position α_{inch}, the limiting pedal position α_{Pedal,grenz} thus works out at:

$$O \leq {α}_{Pedal , grenz} = {α}_{max} \frac{{v}_{fahr}}{{v}_{max}} + c {α}_{inch} \leq 1 \qquad ( 4 )$$

Before the mode of procedure according to the invention is explained in still greater detail with the aid of the charts in FIGS. 3 to 6, the sequence will be explained again in a simplified chart in FIG. 2 regarding the procedural sequence. The position α_{Pedal} of the accelerator pedal 22 is first of all determined in step 30. The actual speed vᵢₛₜ of the vehicle is determined in step 31 of the method. In addition, the position α_{inch} of the inching pedal 23 is determined in step 32 as a further input quantity for calculating the transmission gradient

$$\frac{d }{d t} {r}_{soll} ( t ) .$$

The allowance-making value α_{Pedal,grenz} is calculated from the actual speed vᵢₛₜ and the inching pedal position α_{inch}. A characteristic quantity for the desire for acceleration (α_{Pedal}−α_{Pedal,grenz}) is calculated in step S34, with the limiting pedal position α_{Pedal,grenz} as the allowance-making value. The difference between the accelerator pedal position α_{Pedal} and the allowance-making value α_{Pedal,grenz} is calculated for that purpose. The transmission gradient

$$\frac{d }{d t} {r}_{soll} ( t )$$

is then calculated in step 35 on the basis of the characteristic quantity for the desire for acceleration (α_{Pedal}−α_{Pedal,grenz}) from step 34. In addition to said characteristic quantity for the desire for acceleration (α_{Pedal}−α_{Pedal,grenz}), the transmission gradient

$$\frac{d }{d t} {r}_{soll} ( t )$$

contains a parameter m which serves to establish the characteristic profile. This will be explained again below with reference to FIG. 3.

After the transmission gradient

$$\frac{d }{d t} {r}_{soll} ( t )$$

has been determined in step 35, a new ideal transmission value rₛₒₗₗ(t+Δt) is calculated from a previous ideal transmission value r(t), the transmission gradient

$$\frac{d }{d t} {r}_{soll} ( t )$$

and a time interval Δt in accordance with equation 1. In step 37, the ideal transmission ratio rₛₒₗₗ thus determined is realised by setting the hydraulic pump 9 and the hydraulic motor 10 to the corresponding angles of pivoting. This therefore results in a changed speed of travel which takes account of the driver's desire for acceleration. Because of the loop which is to be run through continuously, this altered speed of travel vᵢₛₜ is contained in a new calculation of a new ideal transmission.

The procedure according to the invention allows the rotational speed of the diesel internal combustion engine to be set independently of an acceleration and permits automotive travel during a working operation. FIG. 3 contains a graphic representation for the purpose of explaining the way in which the transmission ratio rₛₒₗₗ(t) is set in accordance with the invention. As directly emerges from correlation 2, a straight line having the pitch m exists for each limiting pedal position α_{Pedal,grenz}. Under these circumstances, the limiting pedal position or allowance-making value α_{Pedal,grenz} establishes the zero passage of the straight line. This is represented in FIG. 3 for the straight line 42 as an example. Under these circumstances, this specific straight line 42 emerges as the allowance-making value α_{Pedal,grenz} on the basis of a specific speed of travel vᵢₛₜ of the vehicle and thus of a specific limiting pedal position. A rise in the speed of travel leads, in accordance with correlation 3, to an increase in the allowance-making value, that is to say, the limiting pedal position α_{Pedal,grenz}, in the direction of the characteristic designated by 43 in FIG. 3. Conversely, a reduction in the speed of travel leads to a displacement of the characteristic in the direction of the characteristic designated by 44.

For the sake of simplicity, only straight lines are represented as characteristics in FIG. 3. However, it is equally possible, by suitable parametrisation of the parameter m, to realise other characteristic profiles, such as is represented, as an example, in the form of the characteristic 45.

Under these circumstances, the determining of the transmission gradient

$$\frac{d }{d t} {r}_{soll} ( t )$$

along the characteristics takes place merely between a minimum transition gradient and a maximum transmission gradient.

Even the making of allowance for the inching pedal position α_{inch}, such as is indicated in correlation 4, can be set individually via a further parameter c. The making of allowance for the inching pedal position α_{inch}, that is to say for a further output requirement and another consumer such as, for example, the working hydraulics, has the same function, since it is likewise contained in the allowance-making value α_{Pedal,grenz}, as an alteration in the speed of travel. This means that a rise in the inching pedal position α_{inch} leads to a displacement of the characteristic in FIG. 3 towards the right. Conversely, a reduction in the angle of the inching pedal 23 leads to a reduction in the limiting pedal position α_{Pedal,grenz}, and this corresponds to a displacement of the characteristic in FIG. 3 towards the left.

Various driving situations are represented in FIGS. 4 to 6 for illustration purposes.

First of all, a driving situation in which the accelerator pedal 22 is set to an angle α₁ is represented in FIG. 4. The speed vᵢₛₜ of the vehicle at this point in time would still be relatively low, so that the characteristic 42′ in the figure has a zero passage close to a pedal angle α=0. The association of the transmission gradient with the pedal position α₁ produces the maximum possible transmission gradient at the point p₁.

As a result of this, for each time interval Δt which arises because of that scanning rate of a D/A converter at which the pedal positions of the accelerator pedal 22 and inching pedal 23 are scanned, the transmission ratio rₛₒₗₗ(t) is increased by the value indicated by the maximum transmission gradient. The resulting acceleration of the vehicle leads to a rise in the actual speed of the vehicle vᵢₛₜ.

As has already been described in the explanation of FIG. 3, this corresponds to the displacement of the characteristic 42′ in the direction indicated by the arrow in FIG. 4.

As soon as the characteristic 42′ intersects the straight line indicating the maximum transmission gradient

$$\frac{d }{d t} {r}_{soll} ( t )$$

at the point P1, the transmission gradient is determined by said characteristic 42′.

In FIG. 5, the accelerated travel previously indicated is represented at a later point in time. The characteristic 42′ has shifted towards the right because of the acceleration and of the rise in speed vᵢₛₜ linked with the latter, so that the transmission gradient

$$\frac{d }{d t} {r}_{soll} ( t )$$

is determined by means of the point P2 on the basis of the pedal position α₁.

This process continues until the characteristic 42′ in FIG. 5 is displaced towards the right to the point where the value for the limiting pedal position α_{Pedal,grenz} coincides with the pedal position α₁. As a result of this, the characteristic quantity for the desire for acceleration in equation (2) is zero and no further change occurs in the transmission r(t) of the hydrostatic gear unit 3.

The above remarks regarding the displacement of the characteristic 42′ apply, mutatis mutandis, to the retraction of the accelerator pedal 22. Represented as an example in FIG. 5 is an accelerator pedal position α₂ which leads to a minimal transmission gradient

$$\frac{d }{d t} r ( t ) {\vert}_{min}$$

at point p3.

On the other hand, the making of allowance for an inching pedal position α_{inch} which differs from zero is represented in FIG. 6, adopting the situation in FIG. 1 as the starting point. The making of allowance for the position of the inching pedal 23 in the allowance-making value α_{Pedal,grenz} leads to a displacement of the characteristic 42′, such as would be produced without making allowance for the inching pedal 23, to the new characteristic 46. As a result of this, at the accelerator pedal position α₁, the transmission gradient

$$\frac{d }{d t} {r}_{soll} ( t )$$

is reduced, compared to the situation represented in FIG. 4, even at a low speed of travel. A lower acceleration occurs, since not all the output of the engine is available exclusively for the traction drive.

The method according to the invention has the advantage that the accelerator pedal 22 serves directly for presetting the acceleration. That is to say, the greater the desire for acceleration manifested by the driver, i.e. the greater the accelerator pedal position α_{Pedal}, the greater, too, is the transmission gradient

$$\frac{d }{d t} {r}_{soll} ( t )$$

and thus the change in transmission per time interval. Conversely, an increase in the pedal angle α_{inch} at the inching pedal 23 produces a reduction in the transmission gradient

$$\frac{d }{d t} {r}_{soll} ( t ) .$$

With the mode of procedure described, a final transmission exists at each pedal position α_{Pedal}, the transmission ratio r(t) set in each case approximating asymptotically to this final transmission. By parametrisation of the parameters m and c, simple adaptation of the traction strategy required in each case is possible, for example to particular conditions of use of a vehicle. In particular, the pedal characteristic can be adapted in a simple manner.

The method described can be used, both for working machines with hydrostatic gear units and for working machines with infinitely variable output-branching gear units.

1. Method of controlling a transmission ratio in an infinitely variable gear unit, said method comprising the following steps:
the detecting of an accelerator pedal position (α_{Pedal});
the detecting of an actual speed of travel (vᵢₛₜ);
the determining of a transmission gradient
$$( \frac{d }{d t} {r}_{soll} ( t ) \cdot Δ t ) ;$$
for the infinitely variable gear unit while allowing for the actual speed of travel (vᵢₛₜ) and the accelerator pedal position (α_{Pedal});
the determining of an ideal transmission value as the sum of an actual transmission ratio (rₛₒₗₗ(t)) and a transmission-changing value
$$( \frac{d }{d t} {r}_{soll} ( t ) )$$
and
the setting of the new transmission value (rₛₒₗₗ(t+Δt)) of the infinitely variable gear unit.

2. Method according to claim 1, wherein, for the purpose of allowing for the speed of travel (vᵢₛₜ) when calculating the transmission gradient
$$( \frac{d }{d t} {r}_{soll} ) ,$$
an allowance-making value (α_{Pedal,grenz}) is calculated which contains a ratio of the actual speed of travel and a maximum speed of travel.

3. Method according to claim 2, wherein,
a characteristic quantity for the desire for acceleration is calculated, for the purpose of determining the transmission gradient
$$( \frac{d }{d t} {r}_{soll} ) ,$$
from the allowance-making value (α_{Pedal,grenz}) and the accelerator pedal position (α_{Pedal}) detected.

4. Method according to claim 3, wherein
for the purpose of calculating the characteristic quantity for the desire for acceleration (α_{Pedal-}α_{Pedal,grenz}), a difference is formed between the accelerator pedal position (α_{Pedal}) detected and the allowance-making value (α_{Pedal,grenz}).

5. Method according to claim 2, that,
in addition to the actual speed of travel, another output requirement (c·α_{inch}), is allowed for when calculating the allowance-making value (α_{Pedal,grenz}).
